(19) United States
(12) Patent Application Publication
(10) Pub. No.: US 2026/0208756 A1
(43) Pub. Date: Jul. 23, 2026

(54) CONTROL DEVICE, CONTROL METHOD, AND STORAGE MEDIUM

(71) Applicant: HONDA MOTOR CO., LTD., Tokyo (JP)

(72) Inventors: Jin OKUMURA, Tokyo (JP); Tamito KAWATE, Tokyo (JP); Hideto SHIOTANI, Tokyo (JP)

(73) Assignee: HONDA MOTOR CO., LTD., Tokyo (JP)

(21) Appl. No.: 19/449,474

(22) Filed: Jan. 15, 2026

(30) Foreign Application Priority Data
Jan. 17, 2025 (JP) 202510077848.2

(51) Int. Cl. B60W 50/14; B60K 35/28; B60W 30/06; B60W 30/14; G06V 20/58

(52) U.S. Cl. CPC B60W 50/14; B60K 35/28; B60W 30/06; B60W 30/146; G06V 20/586; B60K 2360/166; B60K 2360/178; B60K 2360/1868; B60K 2360/191; B60W 2050/146; B60W 2420/403; B60W 2420/408; B60W 2420/54; B60W 2520/10; B60W 2554/20; B60W 2554/40; B60W 2554/80

(57) ABSTRACT

A control device that performs movement control on a moving body configured to autonomously travel to a candidate parking position and stop includes a processor configured to: acquire recognition data of an external environment of the moving body; set a candidate parking position based on the recognition data; generate one or more driving paths connecting a current position of the moving body to the candidate parking position; display the candidate parking position and at least one driving path of the one or more driving paths; and perform movement control on the moving body. The processor is configured to set a predetermined driving speed of the moving body along at least one driving path of the one or more driving paths based on the recognition data, and the processor is configured to change a display manner of the at least one driving path according to the predetermined driving speed.

### CROSS REFERENCE TO RELATED APPLICATIONS

This application is based upon and claims the benefit of priority from prior Chinese patent application No. 202510077848.2, filed on January 17, 2025, the entire contents of which are incorporated herein by reference.

### TECHNICAL FIELD

The present disclosure relates to a control device, a control method, and a storage medium.

### BACKGROUND ART

In recent years, in order to provide access to sustainable transport systems that take into account disadvantaged transport participants, there are increasingly more related measures. As one of the measures, in order to further improve the safety and convenience of traffic, research and development of driving assistance technologies and autonomous driving technologies of vehicles such as automobiles are being conducted.

For example, in automatic parking techniques to detect a parking area, generate a path from a current position of the vehicle to a target parking area, and autonomously move and park, a technique of displaying the generated path on a display has been known as disclosed in CN108146432B.

### SUMMARY OF INVENTION

It is difficult for a user to grasp how the vehicle will move along the path even if the generated path is displayed. In addition, when the generated path is displayed, although a peripheral image of the vehicle is also displayed, since obstacle information present around the vehicle is not displayed, the user cannot know whether the automatic parking system has recognized an obstacle. The user may turn off an automatic parking function due to a sense of insecurity caused by these situations.

Aspects of the present disclosure relate to providing a control device, a control method and a computer-readable storage medium storing a control program that can facilitate the use of an automatic parking function by prompting information that can give a user a sense of security during automatic parking.

According to an aspect of the present disclosure, there is provided a control device that performs movement control on a moving body configured to autonomously travel to a candidate parking position and stop, the control device including a processor configured to:

acquire recognition data of an external environment of the moving body;

set a candidate parking position based on the recognition data;

generate one or more driving paths connecting a current position of the moving body to the candidate parking position;

display the candidate parking position and at least one driving path of the one or more driving paths; and

perform movement control on the moving body, in which

the processor is configured to set a predetermined driving speed of the moving body along at least one driving path of the one or more driving paths based on the recognition data, and

the processor is configured to change a display manner of the at least one driving path according to the predetermined driving speed.

According to another aspect of the present disclosure, there is provided a control method for performing, by a control device, movement control on a moving body configured to autonomously travel to a candidate parking position and stop, the control method including:

acquiring recognition data of an external environment of the moving body;

setting a candidate parking position based on the recognition data;

generating one or more driving paths connecting a current position of the moving body to the candidate parking position;

displaying the candidate parking position and the one or more driving paths; and

performing movement control on the moving body, wherein

the control method further includes:

setting a predetermined driving speed along at least one driving path of the one or more driving paths based on the recognition data, and

changing a display manner of the at least one driving path according to the predetermined driving speed.

According to another aspect of the present disclosure, there is provided a non-transitory computer-readable storage medium storing a control program for causing a processor of a control device to execute a process, the process including:

acquiring recognition data of an external environment of the moving body;

setting a candidate parking position based on the recognition data;

generating one or more driving paths connecting a current position of the moving body to the candidate parking position;

displaying the candidate parking position and the one or more driving paths; and

performing movement control on the moving body, in which

the process further includes:

setting a predetermined driving speed along at least one driving path of the one or more driving paths based on the recognition data, and

changing a display manner of the at least one driving path according to the predetermined driving speed.

According to the present disclosure, the use of the automatic parking function can be facilitated by prompting information that can give the user a sense of security during the automatic parking. Further, the present disclosure is helpful to improve traffic safety and contribute to the development of sustainable traffic systems.

### BRIEF DESCRIPTION OF DRAWINGS

Exemplary embodiment(s) of the present invention will be described in detail based on the following figures, wherein:

FIG. 1 is a block diagram of a schematic configuration of a vehicle equipped with a control device according to an embodiment of the present disclosure;

FIG. 2 is a schematic diagram illustrating a parking space search process according to an embodiment of the present disclosure;

FIG. 3 is a schematic diagram of an example of parking path generation according to the embodiment of the present disclosure;

FIG. 4 is a schematic diagram of displaying a predicted speed on a parking path according to the embodiment of the present disclosure;

FIG. 5 is a schematic diagram illustrating objects near the parking path according to the embodiment of the present disclosure; and

FIG. 6 is a schematic diagram of an application scenario of a control device according to the embodiment of the present disclosure.

### DESCRIPTION OF EMBODIMENTS

Hereinafter, an embodiment of the vehicle control device of the present disclosure will be described with reference to the drawings. The following embodiment does not limit the present disclosure, and not all elements described in the following embodiment are necessary for the present disclosure. In addition, two or more elements described in the following embodiment may be freely combined without departing from the scope of the present disclosure. In addition, the same or similar elements are denoted by the same or similar reference signs below, and the description thereof may be omitted or simplified.

### Vehicle Equipped with Control Device

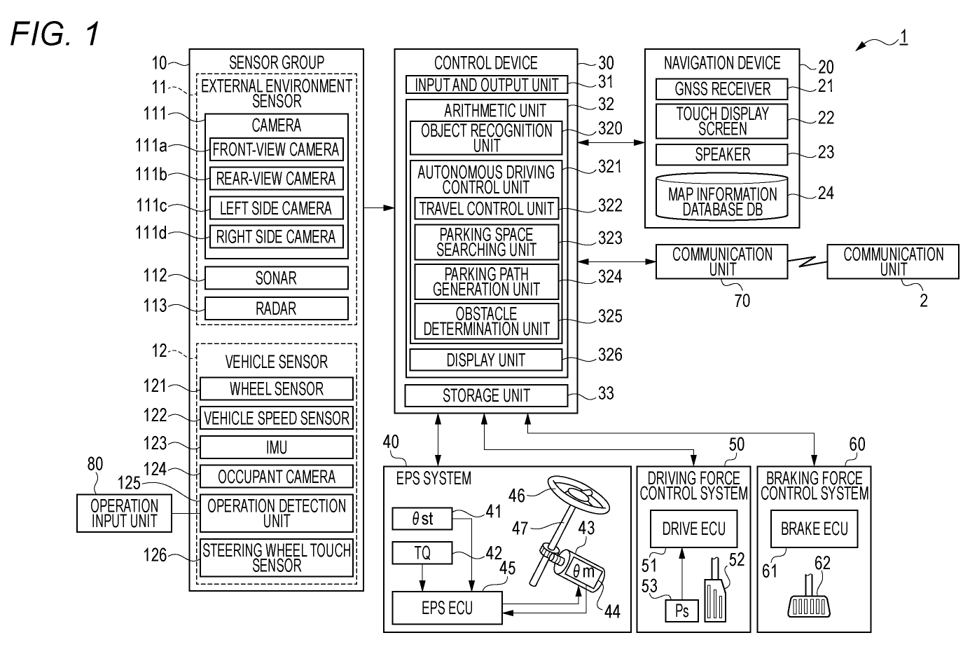

First, a vehicle 1 of the present embodiment will be described. FIG. 1 is a block diagram illustrating a configuration of the vehicle 1 equipped with a control device 30 according to the embodiment. The vehicle 1 is an automobile including a drive source (not illustrated) and wheels (not illustrated) including drive wheels driven by power of the drive source and steered wheels. As an example, the vehicle 1 may be a four-wheeled automobile with a pair of left and right front wheels and a pair of left and right rear wheels.

The drive source of the vehicle 1 may be an electric motor, an internal combustion engine such as a gasoline engine or a diesel engine, or a combination of the electric motor and the internal combustion engine. In addition, the drive source of the vehicle 1 may drive the pair of left and right front wheels, and may drive the pair of left and right rear wheels, or may drive the four wheels, that is, the pair of left and right front wheels and rear wheels. Either the front wheels or the rear wheels of the vehicle 1 may be steered wheels that are steerable, or both the front wheels and the rear wheels may be steered wheels that are steerable.

The vehicle 1 can perform autonomous driving and driving assistance for automatically controlling driving operations. The autonomous driving defined herein means that all driving operations such as recognition or monitoring of a travel environment and a surrounding condition, and starting, acceleration and deceleration, steering, and stopping are performed by a vehicle system. In addition, the driving assistance means that a part of driving operations such as starting, acceleration and deceleration, steering, and stopping is performed by the vehicle system, for example, an automatic parking system (APS), a lane keep assist system (LKAS), and adaptive cruise control (ACC). In the embodiment illustrated below, for example, the vehicle 1 is moved to a predetermined parking position as a traget position. In addition, there may be a plurality of driving control levels for the autonomous driving and the driving assistance, for example, may be defined based on levels 0 to 5 formulated by Society of Automotive Engineers (SAE). In the driving control level, a larger level number indicates a lighter operation burden of a driver (in other words, a larger level number indicates a higher automation degree). Since specific contents of levels 0 to 5 are known contents, the description thereof is omitted here.

The vehicle 1 includes a sensor group 10, a navigation device 20, the control device 30, an electric power steering (EPS) system 40, a driving force control system 50, a braking force control system 60, a communication unit 70, and an operation input unit 80.

The sensor group 10 includes an external environment sensor 11 that acquires information related to the surrounding of the vehicle 1 and a vehicle sensor 12 that acquires information related to the vehicle 1. The information (in other words, a detection value) acquired by each sensor provided in the sensor group 10 is output to the control device 30.

The external environment sensor 11 includes a camera 111, a sonar 112, and a radar 113. The camera 111 is a digital camera that images the periphery of the vehicle 1 including the vehicle 1 and outputs image data of the acquired peripheral images to the control device 30. In the present embodiment, since the vehicle 1 can perform the autonomous driving and the automatic parking, in order to acquire an omnidirectional peripheral image of the vehicle 1, the vehicle 1 includes a front-view camera 111a, a rear-view camera 111b, a left side camera 111c, and a right side camera 111d. In addition, the camera 111 does not need to include all of the cameras 111a to 111d, as long as it includes at least the cameras required for the autonomous driving and the automatic parking.

The front-view camera 111a is, for example, disposed at an upper portion of a front windshield or a front bumper in the vehicle to image a front area of the vehicle 1. The rear-view camera 111b is, for example, disposed at a rear bumper to image a rear area of the vehicle 1. The left side camera 111c is, for example, disposed at a left side mirror or the like to image a left area of the vehicle 1. The right side camera 111d is, for example, disposed at a right side mirror or the like to image a right area of the vehicle 1. Each of the cameras 111a to 111d may be, for example, a digital camera using imaging elements such as a charge coupled device (CCD) and a complementary metal oxide semiconductor (CMOS). In addition, in the following description, the front-view camera 111a, the rear-view camera 111b, the left side camera 111c, and the right side camera 111d are referred to as the "camera 111".

The sonar 112 transmits sound waves to the periphery of the vehicle 1 (for example, the front, the rear, and the sides of the vehicle 1), and detects a distance to and an orientation of an object present around the vehicle 1 by receiving reflected waves from the object. The detected information is sent to the control device 30 at a prescribed frequency. The radar 113 transmits an electric wave to the periphery of the vehicle 1 including the front of the vehicle 1, and detects a distance to and an orientation of an object present around the vehicle 1 by receiving reflected waves from the object. The detected information is sent to the control device 30 at a prescribed frequency. As the radar 113, for example, a millimeter wave radar may be used.

In addition, the external environment sensor 11 may use light detection and ranging (LiDAR) instead of or in addition to the sonar 112 and the radar 113. In this case, the LiDAR transmits laser light to the periphery of the vehicle 1 including the front of the vehicle 1, and detects a distance to and an orientation of an object present around the vehicle 1 by receiving reflected light from the object.

The vehicle sensor 12 includes, for example, a wheel sensor 121, a vehicle speed sensor 122, an inertial measurement unit (IMU) 123, an occupant camera 124, an operation detection unit 125, and a steering wheel touch sensor 126.

The wheel sensor 121 detects a rotation angle of one or more of the wheels provided in the vehicle 1. As an example, the wheel sensor 121 detects respective rotation angles of a left rear wheel and a right rear wheel. As the wheel sensor 121, for example, an angle sensor and a displacement sensor may be used.

The vehicle speed sensor 122 detects a driving speed of the vehicle 1 (in other words, a movement speed of a vehicle body), that is, a vehicle speed. For example, the vehicle speed sensor 122 detects the vehicle speed based on the number of revolutions of a counter shaft (not illustrated) provided in the vehicle 1.

The inertial measurement unit 123 detects angular velocities in pitch, roll, and yaw directions of the vehicle 1 and accelerations in a front-rear direction, a left-right direction, and an up-down direction of the vehicle 1. In addition, the vehicle sensor 12 may replace the inertial measurement unit 123 with an acceleration sensor that detects acceleration in a predetermined direction of the vehicle 1 and a gyroscope sensor that detects an angular velocity in the predetermined direction of the vehicle 1.

The occupant camera 124 is a digital camera that images a vehicle interior of the vehicle 1 and outputs image data of the acquired in-vehicle image to the control device 30. For example, the occupant camera 124 may be a so-called "driver monitoring camera" disposed to be able to image a head of the driver sitting on a driver's seat of the vehicle 1 from the front (in other words, to image a face). As the occupant camera 124, similar to the camera 111, a digital camera using imaging elements such as the CCD and the CMOS may be used. In addition, in the present embodiment, the image data of the in-vehicle image acquired by imaging the vehicle interior by the occupant camera 124 is information capable of specifying a ling-of-sight direction of the driver.

The operation detection unit 125 detects an operation performed by the operation input unit 80, which is set to be operable by an user such as the driver. In the present embodiment, the operation input unit 80 includes, for example, an operation switch (not illustrated) that receives switching operations for starting (in other words, on) and stopping (in other words, off) the autonomous driving and the automatic parking. In this case, the operation detection unit 125 can detect the starting and stopping operations of the autonomous driving and the automatic parking.

The steering wheel touch sensor 126 detects whether the steering wheel 46 of the vehicle 1 is properly held. For example, the steering wheel touch sensor 126 is implemented by an electrostatic capacitive sensor and the like. In this case, the electrostatic capacitive sensor is disposed at a portion that the driver can touch when the steering wheel 46 is properly held.

The navigation device 20 includes a global navigation satellite system (GNSS) receiver 21, a touch display screen 22, and a speaker 23. The navigation device 20 includes a storage unit (not illustrated) including a flash memory and the like. The storage unit of the navigation device 20 stores a map information database (DB) 24 and the like.

The GNSS receiver 21 determines a current position of the vehicle 1 (for example, the latitude and longitude of the position of the vehicle 1) based on signals received from GNSS satellites. In addition, the navigation device 20 can, for example, acquire a detection result of the vehicle sensor 12 (for example, the wheel sensor 121 and the vehicle speed sensor 122) through the control device 30, and determine or supplement the current position of the vehicle 1 through an inertial navigation system (INS) by using the detection value of the vehicle sensor 12.

The touch display screen 22 functions as an input device for receiving various information inputs to the control device 30 and a display device controlled by the control device 30. The touch display screen 22 is composed of, for example, a display device such as a liquid crystal display and an organic light emitting diode (OLED) and a positioning device (such as a touch panel). The speaker 23 is configured to output sound to an occupant (for example, a driver) of the vehicle 1.

For example, the navigation device 20 searches for a path (hereinafter, also referred to as a "guidance path") from the current position of the vehicle 1 to a destination set by the driver through the touch display screen 22 by referring to the map information database 24. Then, the navigation device 20 uses the touch display screen 22 and the speaker 23 to perform path guidance based on the found guidance path. In addition, the navigation device 20 may perform predetermined display on the touch display screen 22 according to an instruction of the control device 30. Specific display descriptions are described below. In addition, the navigation device 20 may output, for example, to the control device 30, predetermined information such as information indicating a current position of the specific vehicle 1 and information indicating an operation received through the touch display screen 22.

The EPS system 40 includes, for example, a steering angle sensor 41, a torque sensor 42, an EPS motor 43, a distributor 44, and an EPS ECU 45.

The steering angle sensor 41 detects a steering angle θst of the steering wheel 46 and outputs information on the detected steering angle θst to the EPS ECU 45. The torque sensor 42 detects the torque applied to the steering wheel 46 of the vehicle 1, that is, steering torque TQ, and outputs information on the detected steering torque TQ to the EPS ECU 45.

The EPS motor 43 assists the driver in operation of the steering wheel 46 by applying driving force or reaction force to a steering column 47 connected to the steering wheel 46 according to an instruction of the EPS ECU 45. The distributor 44 detects a rotation angle θm of the EPS motor 43 and outputs information on the detected rotation angle θm to the EPS ECU 45.

The EPS ECU 45, for example, includes a processor for performing various operations, a storage unit including a non-transitory storage medium for storing various pieces of information, and an input and output unit for controlling data input and output inside and outside the EPS ECU 45 (none of which are illustrated), is a computer for controlling the EPS system 40 (for example, the EPS motor 43), and is implemented by one or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the distributor 44, and the like. In addition, the EPS ECU 45 can control the EPS system 40 according to the instruction of the control device 30.

Further, the EPS system 40 (for example, the EPS ECU 45) can output, to the control device 30, information on the steering angle θst detected by the steering angle sensor 41, the steering torque TQ detected by the torque sensor 42, the rotation angle θm detected by the distributor 44, and the like. Additionally, the EPS system 40 (for example, the EPS ECU 45) can output information on a steering speed ω of the steering wheel 46 to the control device 30. In this case, the steering speed ω can be acquired, for example, by time differentiating the steering angle θst.

The driving force control system 50 includes a drive ECU 51 configured to control the driving force of the vehicle 1. The drive ECU 51, for example, includes a processor for performing various operations, a storage unit including a non-transitory storage medium for storing various pieces of information, and an input and output unit for controlling data input and output inside and outside the drive ECU 51 (none of which are illustrated), is a computer for controlling the driving force control system 50, and is implemented by one or more ECUs. For example, the drive ECU 51 controls the driving force output from the drive source of the vehicle 1 based on an operation amount of an accelerator pedal 52 provided in the vehicle 1 and a detection value of a gear position sensor 53 that detects a gear position Ps of a shifting device (for example, a shift lever and a shift switch, not illustrated). Further, as described above, the drive source is an internal combustion engine or an electric motor, and the drive ECU 51 controls the output thereof based on the amount of operation of the accelerator pedal 52 and the gear position Ps. In addition, the drive ECU 51 may also control the driving force control system 50 (for example, the drive source) according to the instruction of the control device 30.

The braking force control system 60 includes a brake ECU 61 configured to control braking force of the vehicle 1. The brake ECU 61, for example, includes a processor for performing various operations, a storage unit including a non-transitory storage medium for storing various pieces of information, and an input and output unit for controlling data input and output inside and outside the brake ECU 61 (none of which are illustrated), is a computer for controlling the braking force control system 60, and is implemented by one or more ECUs. For example, the brake ECU 61 controls the braking force of the vehicle 1 by controlling a brake device (not illustrated) provided in the vehicle 1 based on the operation of the brake pedal 62 provided in the vehicle 1. Here, the brake device includes, for example, a brake caliper, a hydraulic cylinder that transmits hydraulic pressure to the brake caliper, and an electric motor that generates hydraulic pressure in the hydraulic cylinder. The brake ECU 61 then controls the electric motor of the brake device to generate a braking force corresponding to the operation of the brake pedal 62. In addition, the brake ECU 61 may also control the braking force control system 60 according to the instruction of the control device 30.

The communication unit 70 is a communication interface that communicates with the external device 2 according to a control instruction of the control device 30. That is, the control device 30 can communicate with the external device 2 through the communication unit 70. Examples of the external device 2 include a terminal device (such as a smartphone) of the driver and a server device managed by a manufacturer of the vehicle 1. In addition, the communication between the vehicle 1 and the external device 2 may use a mobile communication network such as a cellular network, WI-FI (registered trademark), bluetooth (registered trademark), or the like.

### Structure of Control Device

The control device 30 includes, for example, an input and output unit 31 for controlling input and output of internal and external data, an arithmetic unit 32 for performing various operations, a storage unit 33, which is a non-transitory storage medium, for storing various pieces of information, and a display unit 326 for displaying various pieces of information, and the like, and is a computer for collectively controlling the whole vehicle 1.

The control device 30 is cooperatively implemented by one electronic control unit (ECU) or a plurality of ECUs. In addition, since the control device 30 replaces the driver to performs driving assistance such as controlling the vehicle in place of the driver, it can also be referred to as a control device of an advanced driver assistance system (ADAS ECU). Specific examples of the configuration and control of the control device 30 including the storage unit 33 will be described later, and will not be described here.

The arithmetic unit 32 includes an object recognition unit 320, an autonomous driving control unit 321, a display unit 326, and the like.

The object recognition unit 320 performs sensor fusion processing on detection results from the camera 10, the radar 13, and a detector 14 to recognize information such as a position, a type, and a speed of an object. The object recognition unit 320 outputs the recognition result to the autonomous driving control unit 321.

The autonomous driving control unit 321 includes a travel control unit 322, a parking space searching unit 321, a parking path generation unit 324, an obstacle determination unit 325, and the like.

### Parking Space Search and Parking Path Generation

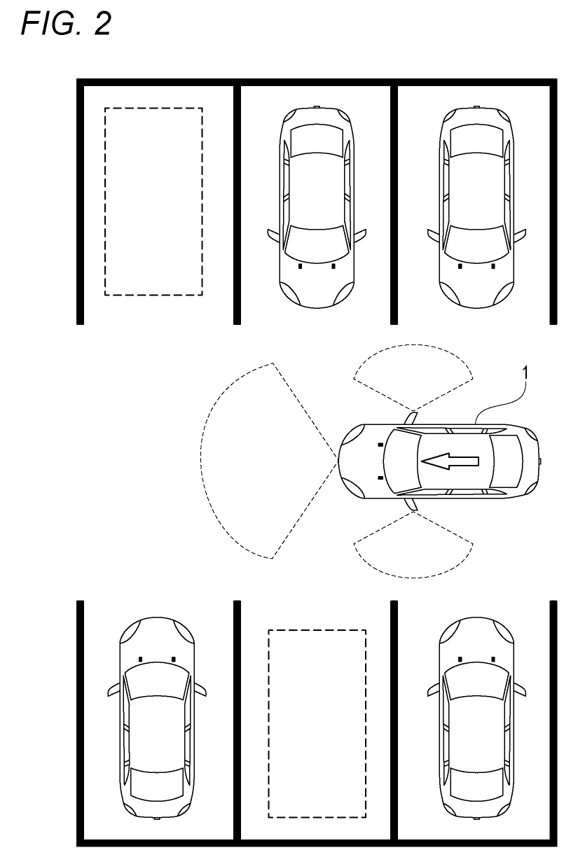

The parking space searching unit 321 searches for a parking space in a forward direction or a reverse direction of the vehicle 1. FIG. 2 is a schematic diagram illustrating that the vehicle 1 searches for the parking space in the forward direction, and a white arrow in FIG. 2 represents a traveling direction of the vehicle 1. Sector regions in FIG. 2 schematically represent a case of exploration using the sonar 112.

During searching, the parking space searching unit 321 receives signals detected by the external environment sensor 11 such as the front-view camera 111a, the sonar 112, and the radar 113, and acquires position information of parked vehicles in a parking lot by analyzing these signals. Specifically, the vehicle 1 acquires an image in front of the vehicle through the front-view camera 111a, and acquires a position of an object in front through the sonar and the radar in front. In addition, the vehicle acquires images of the left and right sides of the vehicle through the left and right cameras 111c and 111d, and acquires positions of objects on the left and right sides through sonars and the radars on the left and right sides.

For example, the parking space searching unit 321 can process the images captured by the camera 111, recognize ground markings of the parking space, and recognize another parked vehicle. A distance to and orientation information of the other vehicle detected by the sonar 112 and the radar 113 are then analyzed to determine the accurate position of the other parked vehicles. By comprehensively analyzing these pieces of information, the parking space searching unit 321 can determine the position and size of a vacant parking space and a relative positional relationship with the vehicle 1. In addition, the parking space searching unit 321 generates a schematic layout diagram of parking spaces according to the data.

As illustrated in FIG. 2, in the generated schematic layout diagram of the parking spaces, four vehicles are parked in the parking lot, and there are two vehicles on the left and right sides of the vehicle 1. At the same time, there are two vacant parking spaces in the parking lot, one of which is located to the right front of the vehicle 1 in the traveling direction (illustrated by an upper dashed box in the figure), and the other is located to the left front of the vehicle 1 (illustrated by a lower dashed box in the figure). The recognized available parking space can be displayed on the touch display screen 22 in the form of, for example, a dashed box, which can facilitate confirmation and selection by the driver. A display manner of the available parking spaces is not limited to a dashed box, for example, may be another manner such as a solid box or a block.

The parking space searching unit 321 may also acquire map data of the parking lot from the map information database 24. The map data includes information such as an overall layout of the parking lot, the size of a standard parking space, and a passage width. By combining the map data with the data detected by the external environment sensor 11 in real time, the parking space searching unit 321 can generate a more accurate and complete schematic layout diagram of the parking spaces in the parking lot, which can help the driver understand the situation of the parking lot more intuitively and better select a suitable parking space.

The suitable parking space may be selected by the user on the touch display screen 22, or may be automatically selected by a control system according to the distance to the parking space.

The parking path generation unit 323 can generate a plurality of optional parking paths based on vacant parking spaces found by the parking space searching unit 321. For example, paths to the parking space illustrated in the upper dashed box in FIG. 2 and the lower dashed box in FIG. 2 can be generated, respectively.

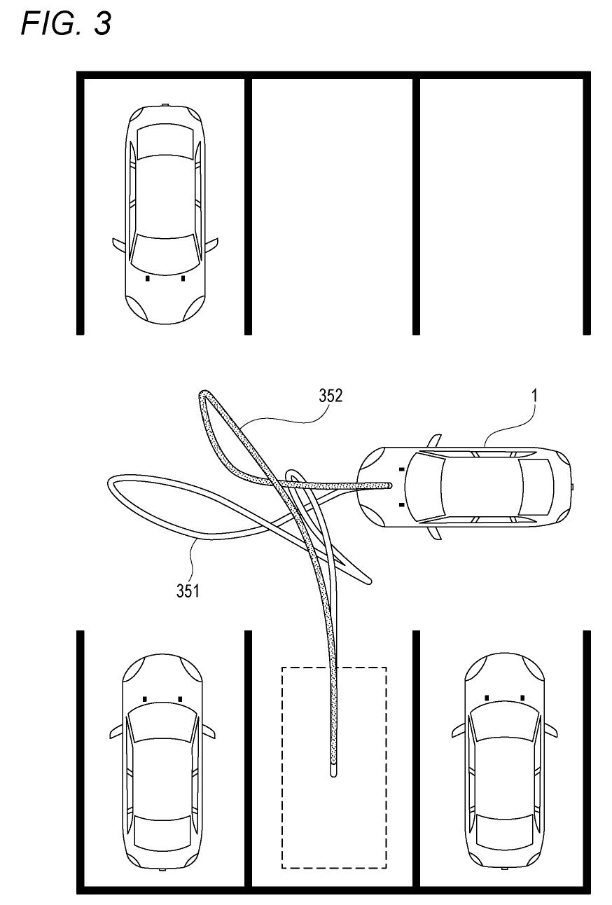

In a preferred embodiment, for the same parking space, the parking path generation unit 323 may also generate a plurality of different parking paths according to the steering radius of the vehicle 1, a safe distance from the surrounding parked vehicle, an avoidance space during a steering process, and the like. As illustrated in FIG. 3, the parking path generation unit 323 generates two different parking paths 351 and 352 for a selected parking space (that is, indicated by the lower dashed box in FIG. 2).

The parking path 351 illustrated by a white hollow line in FIG. 3 is a route that involves multiple forward and reverse maneuvers to park in the parking space. The route can prevent the front of the vehicle head from approaching the parked vehicle on the upper left in FIG. 3 during a parking process, and although it is time-consuming, it can avoid accidentally scratching other vehicles. The parking path 352 illustrated by a line with dots therein in FIG. 3 is a parking path with a small number of maneuvers, and although it is closer to the vehicle on the upper left in FIG. 3 during driving, the parking can be completed more quickly. In this way, different requirements of the user can be met by setting the plurality of parking paths.

Then, the autonomous driving control unit 321 can control the vehicle to perform operations such as moving forward, turning and reversing, according to the parking path recommended by the user or the system by controlling the travel control unit 322, so as to park the vehicle 1 to a target parking space along the selected parking path.

### Display of Predicted Driving Speed

After the user or the system automatically selects the parking path, the autonomous driving control unit 321 may display a predetermined driving speed on a driving path.

Specifically, the driving speed may be set to at least three levels such as a high speed, a medium speed, and a low speed, for example, the high-speed level is applicable to a straight driving path segment and a normal driving speed when there is no obstacle, the medium-speed level is applicable to a slow turning path segment or a driving speed when a static obstacle is detected, and the low-speed level is applicable to a sharp turning path segment, a reverse parking stage, or a driving speed when a dynamic obstacle is detected.

In a preferred embodiment, information on the predetermined driving speed may be represented by using different colors to represent the driving speed of the vehicle in different path segments. For example, the driving speed is represented by a gradient of a color, a path segment with a darker color represents a faster driving speed, and a path segment with a lighter color represents a slower driving speed. As another example, green may be used to represent the high-speed level, yellow may be used to represent the medium-speed level, and red may be used to represent the low-speed level. Here, lines with different hatchings are used for explanation instead of different colors.

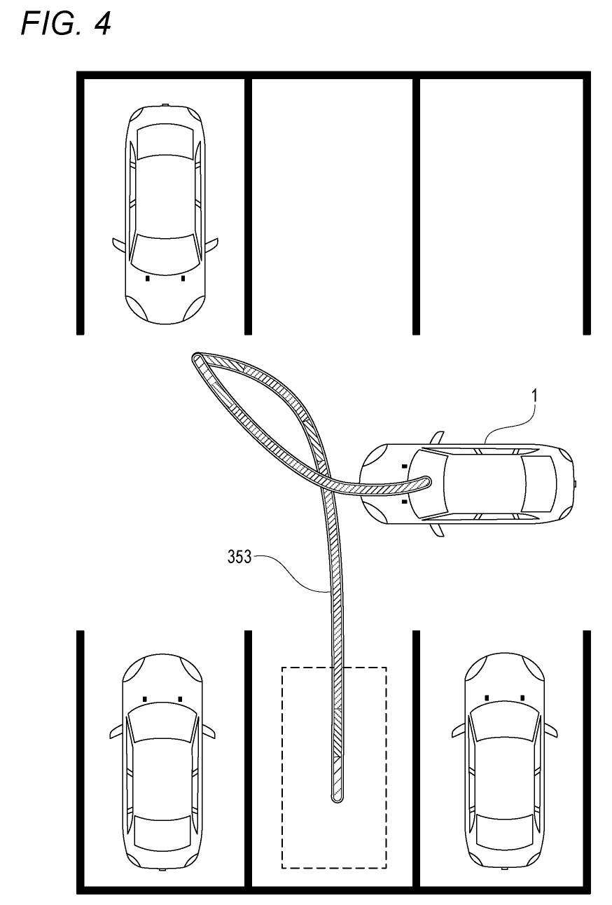

Taking the parking path 353 illustrated in FIG. 4 as an example, when the vehicle 1 starts moving forward to adjust the angle of the vehicle for conveniently parking in the parking space, this path segment is shown with the densest hatching, which means that the driving speed is fast, and as the front of the vehicle approaches the parked vehicle on the upper left, in order to avoid collision and make the vehicle 1 reduce the driving speed, this path segment correspondingly is shown with thinner hatching and then with the thinnest hatching. Then, when the vehicle has safely completed the angle adjustment and is preparing to reverse into a parking garage, the vehicle accelerates slightly but slows down slightly when turning, and this process is represented with the hatching change from the densest to the thinnest. When the rear of the vehicle is aligned with the center of the parking space, the vehicle travels at a higher speed to improve parking efficiency, and this driving path is represented by a longer segment shown with the densest hatching. However, when travelling close to the parked vehicle below, the speed is gradually reduced to avoid scratching until the speed is zero, and the hatching of this path segment correspondingly changes to thinner and then to the thinnest.

Through this intuitive speed change display manner, the user can clearly understand a speed change rule of the vehicle 1 during parking. This design can not only help the user predict a motion state of the vehicle 1, but also enhance the user's trust in the automatic parking system. The user can feel the reliability and safety of the system when seeing that the system will automatically reduce the vehicle speed at an appropriate position.

It should be noted that although FIG. 4 illustrates an example of displaying speed information on only one path, and more preferably, for example, for a plurality of paths as illustrated in FIG. 3, speed information is displayed on each path. In this way, it can help the user predict speed changes along different paths, and it is convenient for the user to select an appropriate path according to personal preferences.

### Recognition of Object

In another preferred embodiment, the object recognition unit 320 recognizes objects within a certain range from the generated parking path, and causes the display unit 326 to display the various recognized objects together before driving along the driving path.

The object recognition unit 320 receives image data from each camera 111 through the input and output unit 31, processes the image data acquired by each camera, fuses a peripheral image around the vehicle 1, and performs object recognition to detect whether a dynamic object is present around the vehicle 1. The dynamic object may be a person, an animal, or another vehicle.

Regarding an object recognition method, the object recognition unit 320 may perform efficient recognition and classification in combination with various technical means, including but not limited to the following methods.

### Image Recognition based on Machine Learning

The image data acquired by the camera 111 is processed by using a pre-trained deep learning model (for example, a convolutional neural network, CNN), and the model recognizes features such as the shape, outline, color of an object to recognize the object as a specific category, such as a human, an animal, a vehicle or another object. If recognized as a human or an animal, it is classified as the dynamic object since this type of target has the potential to move.

### Motion Detection based on Inter-Frame Difference

Consecutive video frames captured by the camera 111 are compared, and an inter-frame difference is calculated to detect whether the object is in motion.

If it is detected that the object is in motion (for example, a change in position or shape), the object is classified as the dynamic object.

This method is particularly suitable for recognizing objects that are not easily distinguished by static features, for example, leaves blown by wind may be excluded, while moving pedestrians or vehicles may be accurately recognized.

### Combination of Image Recognition and Motion Detection

First, the image data acquired by the camera 111 is processed, an object is recognized as a specific category by the model, such as the human, the animal, the vehicle or the other object, and then motion detection based on the inter-frame difference is used to determine whether the object is in motion. If the object is recognized as the human, the animal, or the other vehicle, and it is detected that the object is in motion, the object is classified as the dynamic object, so that recognition accuracy of the dynamic object can be further improved. For example, leaves blown by wind may be excluded, while moving pedestrians or vehicles may be accurately recognized.

In addition, adaptive recognition may also be added according to environmental conditions, for example, infrared cameras or thermal imaging sensors can be introduced for auxiliary recognition at night or in low light conditions.

By combining the above methods, the object recognition unit 320 can accurately classify objects in different environments, ensure the recognition accuracy of dynamic objects, and reduce the misjudgment rate of static objects. Accordingly, not only can the safety of automatic parking and automatic exit be improved, but the adaptability of the system to complex traffic scenarios can be enhanced.

The display unit can display various objects recognized by the object recognition unit 320, for example, in the form of specific icons on the touch display screen 22. For example, when a pedestrian is recognized, the position of the pedestrian will be immediately marked with a humanoid icon, when a moving animal such as a cat or a dog is recognized, the position will be marked with an animal icon, and a moving direction thereof will be indicated with an arrow, and when a static object is recognized, the type, position and size of the static object will be marked with a corresponding icon. The corresponding icon can be, for example, an emoticon used throughout the world, or a more complex icon designed in advance.

Preferably, the display unit 326 only displays objects within a certain range from the parking path to avoid visual confusion of the user caused by too many icons.

### Object Determination

In an embodiment, the obstacle determination unit 325 preferably determines whether an object has a risk based on a plurality of dimensions, then determines the object that may pose a danger as an obstacle, and highlights the object determined as the obstacle.

The first determination criterion is based on movement characteristics of the object. Specifically, for an actively moving dynamic object such as a pedestrian and a bicycle, since a moving direction and a speed are uncertain, there is a possibility of causing driving danger, and it is determined as an obstacle;

for an intermittently moving obstacle such as a vehicle door that may be opened in the parked vehicle, although it is initially stationary, when it is detected that a person is present in the vehicle or the vehicle door is not completely closed, it indicates that the vehicle door may be opened at any time to cause danger, so it is determined as an obstacle; and for static objects such as garbage bins, it is possible to cause danger only when the vehicle 1 is about to approach these static objects, so it is determined as an obstacle only when the vehicle 1 is close to them.

The second determination criterion is based on a relative position relationship with the vehicle 1:

when the object is located on the parking path of the vehicle 1, it is determined as an obstacle; and

in a preferred embodiment, when the object is in a visual field blind spot of the vehicle 1, if a dynamic object is present, in order to help the user know the situation of the visual field blind spot, it may be determined as an obstacle.

The third determination criterion is based on a relative distance and a relative speed between the object and the vehicle 1:

when a distance between the object and the vehicle 1 is less than a preset safe distance threshold, the object is determined as an obstacle;

when it is detected that the object is approaching the vehicle 1, it is determined as an obstacle when the relative speed is large; and

for an object that is moving away from the vehicle 1, the determination of an obstacle may be canceled as the danger disappears.

### Highlighting of Obstacle

The display unit 326 can perform highlighting in different ways according to an object to be determined as the obstacle.

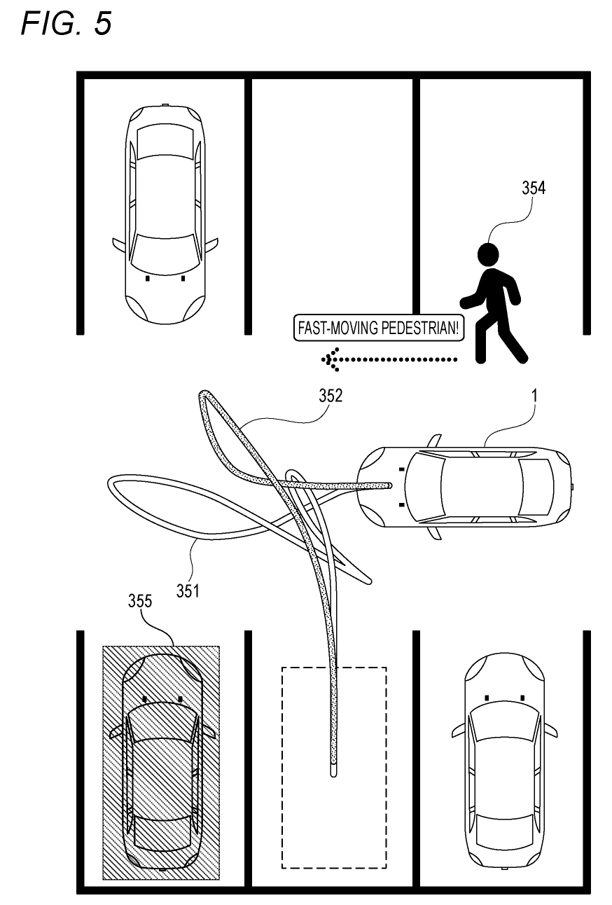

FIG. 5 is an example of highlighting of a specific embodiment of the present disclosure.

When a pedestrian approaching the vehicle is recognized, an icon 354 of the pedestrian may be highlighted. For example, the icon 354 of the pedestrian can be highlighted by making it glow, changing its color, or enlarging it. In addition, an expected moving direction of the pedestrian may also be marked, and the user may also be reminded with a more prominent text.

When a passenger in a nearby parked vehicle, or a sliding door installed on the parked vehicle is recognized, the system locally highlights 355 for the vehicle, for example, by marking the parked vehicle or a sliding door thereof with a specific color or by making it glow to alert the user that people or objects may suddenly appear in that area.

With this hierarchical and focused display manner, the control device 30 can help the user better know the potential danger in the surrounding environment. At the same time, this intuitive risk prompt can also help the user know the reason for the vehicle 1 slowing down or avoiding at a specific position, thereby enhancing the user's trust in the automatic parking system. When the risk recognized by the system is consistent with the user's own observation, the user's recognition of the system determination ability can be enhanced.

The parking path generation unit 42 can prioritize the plurality of optional parking paths according to the type and position of the recognized obstacle. As illustrated in FIG. 5, since the parked vehicle at the upper left position in the figure is recognized, in order to avoid scratching, the system displays a path with higher safety (path 351 in the figure) on an upper layer, and displays a path with a shorter driving distance but a smaller safety margin (path 352 in the figure) on a lower layer. This display manner intuitively recommends a safer parking scheme to the user.

### Change Speed and Change Speed Display based on Obstacle

In addition to the danger of the obstacle, the autonomous driving control unit 321 can also dynamically adjust the driving speed according to the distance between the vehicle and the obstacle.

Specifically, for an obstacle that is a static object, the vehicle speed may not be reduced when the obstacle is far away from the static object, and if the vehicle gradually approaches the obstacle during driving, the vehicle speed may be gradually reduced according to the increase of the size and danger of the obstacle; for an obstacle that is a dynamic object, the system predicts the moving trajectory of the dynamic object, sets a larger threshold of the safe distance, and decelerates at a faster acceleration when the vehicle approaches a preset trajectory of the obstacle; and for a pedestrian within a certain range from the driving path, the vehicle speed should be significantly reduced, and if necessary, the vehicle should be brought to a complete stop until the safety is confirmed.

### Set Mode for Driving Path

A mode may be labeled for each of the generated parking paths. For example, the parking path may be divided into the following four modes.

A high-speed mode: the mode is characterized by adopting a higher driving speed, being as close to obstacles as possible under the premise of ensuring safety, and generating a shortest parking path.

Medium-speed mode: this mode is characterized by a proper reduction in the driving speed in the path, approaching obstacles when necessary, and balancing between the path length and the safety.

Low-speed mode: this mode is characterized by driving at a low speed, avoiding obstacles intentionally, and ensuring a sufficient safe distance from obstacles by increasing the number of U-turns or circuitous parking paths.

Safety priority mode: this mode is characterized by using the lowest driving speed throughout the process, avoiding obstacles to the maximum extent, and ensuring sufficient safety margin even if multiple U-turns are required.

The storage unit 33 records the parking path mode selected by the user during daily use. By analyzing the historical data, the parking path generation unit 42 recognizes the mode that is the user's driving preferences, and in subsequent use, the system will preferentially recommend parking path mode that conforms to the user's driving habits. For example, if the user often selects the safety priority mode, the system will use the safety priority mode as a default recommendation scheme the next time the parking path is generated.

This path recommendation mechanism based on user preferences can not only provide a parking scheme that better conforms to the personal driving habits of the user, but also enable the user to more clearly know the motion trajectory of the vehicle 1 by displaying a plurality of optional schemes, thereby enhancing the user's sense of security and trust in the automatic parking process. At the same time, the user can also switch different parking path modes at any time according to requirements of specific scenarios.

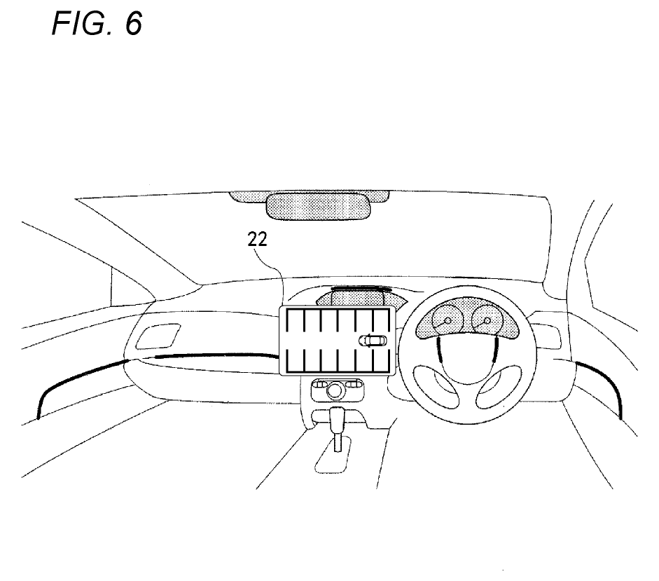

FIG. 6 illustrates an application scenario diagram of the control device of the present disclosure. As illustrated in FIG. 7, the process of the autonomous driving control unit 321 performing automatic parking processing is displayed in real time on the touch display screen of a general control computer in front of the driver's seat. In addition, although the above operations including parking position search, parking path generation, parking path selection and the like are all displayed by the user through the touch display screen 22 of the vehicle 1 itself, the generated parking path may also be displayed on a screen of a mobile phone carried by the user through the communication between the communication unit 70 and the external device 2 such as the mobile phone.

In addition, in the above-described embodiment, an example in which the moving body is used as the vehicle (four-wheeled automobile) is described, but the present disclosure is not limited thereto. For example, the vehicle may alternatively be a two-wheeled vehicle, a Segway, or the like. In addition, the concept of the present disclosure is not limited to vehicles, and may also be applied to robots, ships, aircraft, and the like equipped with a drive source and movable by the power of the drive source.

In addition, the control method described in the above-described embodiment may be implemented by executing a pre-prepared control program. The control program is recorded on a computer-readable storage medium and executed by being reading from the storage medium. In addition, the control program may be provided in the form of a non-transitory storage medium such as a flash memory, or may be provided through a network such as the Internet. The computer that executes the control program may be provided in the control device, or in an electronic device such as a smartphone, a tablet terminal, or a personal computer that can communicate with the control device, or in a server device that can communicate with the control device and the electronic device.

In addition, the present disclosure includes at least the following items, corresponding components or the like in the above-described embodiment are indicated in brackets, but the present disclosure is not limited thereto.

### Scheme 1

A control device (30) that performs movement control on a moving body (vehicle 1) configured to autonomously travel to a candidate parking position and stop, the control device including:

an external environment recognition unit (object recognition unit 320) configured to acquire recognition data of an external environment of the moving body;

a candidate parking position setting unit (parking space searching unit 323) configured to set a candidate parking position based on the recognition data;

a path generation unit (parking path generation unit 324) configured to generate one or more driving paths connecting a current position of the moving body to the candidate parking position;

a display unit (326) configured to display the candidate parking position and at least one driving path of the one or more driving paths; and

a control unit (autonomous driving control unit 321) configured to perform movement control on the moving body, wherein

the control unit sets a predetermined driving speed of the moving body along at least one driving path of the one or more driving paths based on the recognition data, and

the display unit (326) changes a display manner of the at least one driving path according to the predetermined driving speed.

According to the control device in scheme 1, by displaying the parking path to the user, the user can know a trajectory of the autonomous driving in advance, thereby improving the trust of the user for the autonomous driving. In addition, by setting the movement speed for the path and displaying the movement speed, the user can also more intuitively know the speed changes of the vehicle in different path segments, and the user can feel the reliability of the autonomous driving system of the vehicle while improving the safety of automatic parking.

### Scheme 2

The control device according to scheme 1, in which

before starting the movement control to the candidate parking position along a driving path generated based on the recognition data, the display unit (326) highlights an obstacle detected within a predetermined distance range from the driving path.

According to the control device in scheme 2, the obstacle is highlighted before the movement control is started to remind the user of an obstacle near the driving path that may affect driving of the vehicle, which intuitively demonstrates to the user that the autonomous driving system considers multiple aspects to ensure driving safety, increases a sense of security of the user, helps the user to recognize a potential risk in advance, and enhances the safety of an automatic parking process.

### Scheme 3

The control device according to scheme 2, in which

the control unit (321) displays a driving speed of the moving body according to a distance between the moving body and the obstacle, such that the moving body decreases the driving speed as the moving body approaches the obstacle.

The control device (30) of scheme 3 dynamically adjusts and displays the driving speed according to the distance from the obstacle, so that the vehicle automatically slows down when approaching the obstacle, and the safety of the parking process is ensured.

### Scheme 4

The control device according to any one of schemes 1 to 3, in which

the one or more driving paths are each provided with different modes, and

the display unit (326) displays the plurality of driving paths.

According to the control device of scheme 4, different modes are set for different driving paths and the plurality of paths are simultaneously displayed, so that the user can select an appropriate parking scheme based on personal driving preferences, and practicability and adaptability of the autonomous driving system is improved.

### Scheme 5

The control device according to scheme 1, in which

from a time when the driving path is generated to a time when the movement control to the candidate parking position is completed, when a dynamic obstacle approaching the moving body from outside the predetermined distance range from the driving path is detected, the display unit (326) highlights the dynamic obstacle.

The control device of scheme 5 monitors and highlights the dynamic obstacle approaching the vehicle in real time during the entire parking process, and even if the initial position of the dynamic obstacle is outside the preset range, the dynamic obstacle will be highlighted as the dynamic obstacle actively or passively approaches the vehicle, so that the sudden situation can be timely handled.

### Scheme 6

The control device according to scheme 1, in which

when a static obstacle is detected outside the predetermined distance range from the driving path, and a dynamic obstacle is expected to appear from the vicinity of the static obstacle, the display unit (326) highlights the static obstacle.

The control device in scheme 6 can also predict an action of the dynamic obstacle, and can also implement early warning of a potential risk by highlighting the dynamic obstacle that may suddenly appear near the static obstacle, thereby improving active safety performance.

### Scheme 7

A control method that performs movement control on a moving body configured to autonomously travel to a candidate parking position and stop and is performed by a control device (30), the control method including:

acquiring recognition data of an external environment of the moving body;

setting a candidate parking position based on the recognition data;

generating one or more driving paths connecting a current position of the moving body to the candidate parking position;

displaying the candidate parking position and the one or more driving paths; and

performing movement control on the moving body,

the control method further including:

setting a predetermined driving speed along at least one driving path of the one or more driving paths based on the recognition data, and

changing a display manner of the at least one driving path according to the predetermined driving speed.

According to the control method in scheme 7, the obstacle is highlighted before the movement control is started to remind the user of an obstacle near the driving path that may affect driving of the vehicle, which intuitively demonstrates to the user that the autonomous driving system considers multiple aspects to ensure driving safety, increases a sense of security of the user, helps the user to recognize a potential risk in advance, and enhances the safety of an automatic parking process.

### Scheme 8

A non-transitory computer-readable storage medium storing a control program causing a processor of a control device (30) to execute a process, the process including:

acquiring recognition data of an external environment of the moving body;

setting a candidate parking position based on the recognition data;

generating one or more driving paths connecting a current position of the moving body to the candidate parking position;

displaying the candidate parking position and the one or more driving paths; and

performing movement control on the moving body,

the control method further including:

setting a predetermined driving speed along at least one driving path of the one or more driving paths based on the recognition data, and

changing a display manner of the at least one driving path according to the predetermined driving speed.

According to the control program in scheme 8, the obstacle is highlighted before the movement control is started to remind the user of an obstacle near the driving path that may affect driving of the vehicle, which intuitively demonstrates to the user that the autonomous driving system considers multiple aspects to ensure driving safety, increases a sense of security of the user, helps the user to recognize a potential risk in advance, and enhances the safety of an automatic parking process.

What is claimed is:

1. A control device that performs movement control on a moving body configured to autonomously travel to a candidate parking position and stop, the control device comprising a processor configured to:
acquire recognition data of an external environment of the moving body;
set a candidate parking position based on the recognition data;
generate one or more driving paths connecting a current position of the moving body to the candidate parking position;
display the candidate parking position and at least one driving path of the one or more driving paths; and
perform movement control on the moving body, wherein
the processor is configured to set a predetermined driving speed of the moving body along at least one driving path of the one or more driving paths based on the recognition data, and
the processor is configured to change a display manner of the at least one driving path according to the predetermined driving speed.

2. The control device according to claim 1, wherein
before starting the movement control to the candidate parking position along a driving path generated based on the recognition data, the processor is configured to highlight an obetacle detected within a predetermined distance range from the driving path.

3. The control device according to claim 2, wherein
the processor is configured to perform a control to display a driving speed of the moving body according to a distance between the moving body and the obstacle, such that the moving body decreases the driving speed as the moving body approaches the obstacle.

4. The control device according to claim 1, wherein
the one or more driving paths are each provided with different modes, and
the processor is configured to display the plurality of driving paths.

5. The control device according to claim 1, wherein
from a time when the driving path is generated to a time when the movement control to the candidate parking position is completed, when a dynamic obstacle approaching the moving body from outside the predetermined distance range from the driving path is detected, the processor is configured to highlight the dynamic obstacle.

6. The control device according to claim 1, wherein
when a static obstacle is detected outside the predetermined distance range from the driving path, and a dynamic obstacle is expected to appear from the vicinity of the static obstacle, the processor is configured to highlight the static obstacle.

7. A control method for performing, by a control device, movement control on a moving body configured to autonomously travel to a candidate parking position and stop, the control method comprising:
acquiring recognition data of an external environment of the moving body;
setting a candidate parking position based on the recognition data;
generating one or more driving paths connecting a current position of the moving body to the candidate parking position;
displaying the candidate parking position and the one or more driving paths; and
performing movement control on the moving body, wherein
the control method further comprises:
setting a predetermined driving speed along at least one driving path of the one or more driving paths based on the recognition data, and
changing a display manner of the at least one driving path according to the predetermined driving speed.

8. A non-transitory computer-readable storage medium storing a control program for causing a processor of a control device to execute a process, the process comprising:
acquiring recognition data of an external environment of the moving body;
setting a candidate parking position based on the recognition data;
generating one or more driving paths connecting a current position of the moving body to the candidate parking position;
displaying the candidate parking position and the one or more driving paths; and
performing movement control on the moving body, wherein
the process further comprises:
setting a predetermined driving speed along at least one driving path of the one or more driving paths based on the recognition data, and
changing a display manner of the at least one driving path according to the predetermined driving speed.
